(19) United States
(12) Patent Application Publication
(10) Pub. No.: US 2003/0082305 A1
(43) Pub. Date: May 1, 2003

(54) Uv curable woodcoat compositions

(76) Inventor: Roy C Krohn, Fort Gratiot, MI (US)

Correspondence Address: James W Proscia, Brooks & Kushman, 1000 Town Center 22nd Floor, Southfield, MI, 48075, US

(21) Appl. No.: 10/181,018

(22) PCT Filed: Jan. 11, 2001
(86) PCT No.: PCT/US01/00977

(51) Int. Cl. B05D 1/32; B05D 1/02; B05D 1/28; B05D 3/06

(52) U.S. Cl. 427/282; 427/558; 427/421; 427/429; 522/168; 522/178

(57) ABSTRACT

The present invention discloses an ultraviolet light curable woodcoat composition and method for making such a composition that may be used to pace a coating on a wood object. These coatings are clear and provide protection to the wood object. The disclosed composition does not contain any significant amount of volatile organic solvents that do not become incorporated in the active layer after curing.

### TECHNICAL FIELD

The present invention relates to ultraviolet light (uv) curable compositions capable of producing coating on a wood substrate on a wood substrate.

### BACKGROUND OF THE INVENTION

Wood surfaces on decks, teakwood boats, lumber (treated and untreated), and furniture are typically finished with transparent coatings to provide protection and enhance appearance. Traditionally, lacquers containing cellulose compositions were often used to finish wood surfaces. Although inexpensive, these lacquers suffered from poor resistence to physical and chemical attack. Because of these shortcomings, cellulosic lacquers have been supplanted by heat curable coatings. Although more resistant to physical and chemical attack than the cellulosic lacquers, the heat curable coatings suffered from their own disadvantages.

Heat curable compositions require the use of organic solvents that contain a significant amount of volatile organic compounds (VOCs). These VOCs escape into the atmosphere while the heat curable composition dries. Such solvent based systems are undesirable because of the hazards and expenses associated with VOCs. The hazards include water and air pollution and the expenses include the cost of complying with strict government regulation on solvent emission levels. In contrast, UV curable compositions contain reactive monomers instead of solvents; thus eliminating the detrimental effects of the VOCs

The use of heat curable compositions not only raises environmental concerns but other disadvantages exist with their use. Heat curable suffer from slow cure times which lead to decreased productivity. These compositions require high energy for curing due to energy loss as well as the energy required to heat the coating. Additionally, many heat curable compositions yield poor film properties that result in decreased value of the end product.

Although UV curable compositions exhibit superior properties and performance over their heat curable counterparts, UV curable compositions themselves suffer from certain disadvantages. Generally, UV compositions have high molecular weights and a substantial degree of cross linkage due to the highly reactive nature of the composition. As a result, many of these compositions suffer from low durability and resin shrinkage. With the use of many such compositions, an inordinately high amount of UV light is required to cure. New formulations that lessen these problems typically suffer from diminished abrasion, chemical, and scratch resistance as well as low thermal stability and adhesion.

An addition disadvantage of typical UV compositions is their lack of stability which results in dispersion. With some compositions, suspended solids fall out of solution after a period of one to two days. Dispersion adversely affects the gloss and clarity of the finished product. To combat this problem, new compositions have been formulated with higher viscosities which often lessen the flowability of the composition. These viscous formulations rule out spray application and provide for an unsuitably high dipping thickness.

Accordingly, there exists a need to provide environmentally safe UV curable woodcoat compositions which deliver an enhanced finish with increased resistence to physical and chemical degradation. Additionally, there is a need to provide a method of applying the composition which furthers the goal of improved performance.

### SUMMARY OF INVENTION

It is an object of the present invention to provide an improved composition that upon curing by ultraviolet light produces a coating suitable for coating a wood object.

It is another object of the present invention to provide an improved composition suitable for coating a wood object that can be applied by spraying, screen printing, dipping, and brushing.

The present invention discloses an ultraviolet light curable woodcoat composition and method for making such a composition that may be used to produce a coating on a wood object. The disclosed composition does not contain any significant amount of volatile organic solvents that do not become incorporated in the active layer after curing. Specifically, the woodcoat composition contains 5% or less volatile organic solvents by weight.

In accordance with one aspect of the invention, an ultraviolet light curable woodcoat composition is provided. The woodcoat composition comprises a mixture of one or more aliphatic acrylated oligomers, wherein the aliphatic acrylated oligomer mixture is present in an amount of about 10% to 40% of the woodcoat composition. All percentages of the woodcoat composition as expressed in this document refer to the weight percentage of the stated component to the total weight of the woodcoat composition in its fluid state at standard temperature and pressure.

The woodcoat composition preferably comprises an acrylated epoxy oligomer in an amount of about 5% to 20%, an isobornyl acrylate monomer in an amount of about 40% to 60% of the woodcoat composition, a photoinitiator in an amount of about 4% to 12% of the woodcoat composition, and a flow promoting agent in an amount of about 0.1% to 8% of the woodcoat composition.

In accordance with yet another aspect of the invention, a method is provided for depositing a woodcoat coating on a substrate. The method comprises a first step of applying to the substrate a woodcoat fluid-phase composition (“woodcoat composition”). The woodcoat composition comprises a mixture of aliphatic acrylated oligomers, wherein the aliphatic acrylated oligomer is present in an amount of about 10% to 40% of the woodcoat composition. The woodcoat composition also includes an acrylated epoxy oligomer in an amount of about 5% to 20%, an isobornyl acrylate monomer in an amount of about 40% to 60% of the woodcoat composition, a photoinitiator in an amount of about 4% to 12% of the woodcoat composition, and a flow promoting agent in an amount of about 0.1% to 8% of the woodcoat composition.

The method also includes a second step of illuminating the woodcoat composition on the substrate with an ultraviolet light to cause the woodcoat composition to cure into the woodcoat coating.

In accordance with this method, the woodcoat composition can be selectively deposited on the substrate at specific locations where woodcoat plating is desired. It need not be applied to the entire substrate.

### BEST MODE FOR CARRYING OUT THE INVENTION

Woodcoat Compositions

Reference will now be made in detail to presently preferred compositions or embodiments and methods of the invention, which constitute the best modes of practicing the invention presently known to the inventor.

In accordance with one aspect of the invention, a presently preferred ultraviolet light curable woodcoat composition (“woodcoat composition”) is provided. In this preferred embodiment, the woodcoat composition includes a mixture of aliphatic acrylated oligomers. The aliphatic acrylated oligomer mixture is present in an amount of about 10% to 40% of the woodcoat composition. The aliphatic acrylated oligomer mixture is more preferably present in an amount of about 20% to 30%, and most preferably about 24%. The aliphatic acrylated oligomer preferably comprises one or more urethane oligomers. Suitable aliphatic acrylated oligomers include Radcure Ebecryl 244 (aliphatic urethane diacrylate diluted 10% with 1,6-hexanediol diacrylate), Ebecryl 264 (aliphatic urethane triacrylate diluted 15% with 1,6-hexanediol diacrylate), and Ebecryl 284 (aliphatic urethane diacrylate diluted 12% with 1,6-hexanediol diacrylate) urethanes, commercially available from Radcure UCB Corp. of Smyrna, Ga.; Sartomer CN-961E75 (aliphatic urethane diacrylate blended with 25% ethoxylated trimethylol propane triacylate), CN-961H81 (aliphatic urethane diacrylate blended with 19% 2(2-ethoxyethoxy)ethyl acrylate), CN-963A80 (aliphatic urethane diacrylate blended with 20% tripropylene glycol diacrylate), CN-964 (aliphatic urethane diacrylate), CN-966A80 (aliphatic urethane diacrylate blended with 20% tripropylene glycol diacrylate), CN-982A75 (aliphatic urethane diacrylate blended with 25% tripropylene glycol diacrylate) and CN-983 (aliphatic urethane diacrylate), commercially available from Sartomer Corp. of Exton, Pa.; TAB FAIRAD 8010, 8179, 8205, 8210, 8216, 8264, M-E-15, UVU-316, commercially available from TAB Chemicals of Chicago, Ill.; and Echo Resin ALU-303, commercially available from Echo Resins of Versaille, Mo.; and Genomer 4652, commercially available from Rahn Radiation Curing of Aurora, Ill. The preferred aliphatic acrylated oligomers include Ebecryl 264 and Ebecryl 284. Ebecryl 264 is an aliphatic urethane triacrylate supplied as an 85% solution in hexandiol diacrylate. Ebecryl 284 is aliphatic urethane diacrylate of 1200 molecular weight diluted with 1,6-hexanediol diacrylate. Combinations of these materials may also be employed herein.

This preferred woodcoat composition further includes an acrylated epoxy oligomer. The acrylated epoxy oligomer is present in an amount of about 5% to 20%. The acrylated epoxy oligomer is more preferably present in an amount of about 8% to 16%, and most preferably about 12%. Suitable acrylated epoxy oligomers include Radcure Ebecryl 3603 (novolac epoxy acrylate diluted 20% with tripropylene glycol diacrylate), commercially available from Radcure UCB Corp.; Sartomer CN-120 (difunctional bisphenol based epoxy acrylate) and CN124 (difunctional bisphenol based epoxy acrylate), commercially available from Sartomer Corp.; and Echo Resin TME 9310 and 9345, commercially available from Echo Resins. The preferred acrylated epoxy oligomer is Ebecryl 3603, which tri-functional acrylated epoxy novolac. Combinations of these materials may also be employed herein.

The preferred woodcoat composition also includes an isobornyl acrylate monomer in an amount of about 40% to 60%. The isobornyl acrylate monomer is more preferably present in an amount of about 45% to 55%, and most preferably about 52%. Suitable isobornyl acrylate monomers include Sartomer SR-423 (isobornyl methacrylate):

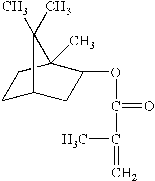

and SR-506 (isobornyl acrylate):

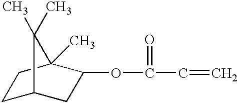

available from Sartomer Corp.; Radcure IBOA (isobornyl acrylate), commercially available from Radcure Corp.; IBOA and IBOMA, commercially available from CPS Chemical; and Genomer 1121, commercially available from Rahn Radiation Curing. The preferred isobornyl acrylate monomers is Radcure IBOA, commercially available from Radcure Corp. Combinations of these materials may also be employed herein.

This preferred woodcoat composition also includes a photoinitiator in an amount of about 4% to 12% of the woodcoat composition. The photoinitiator is more preferably present in an amount of about 6% to 10%, and most preferably about 8%. Suitable photoinitiators include Irgacure 184 (1-hydroxycyclohexyl phenyl ketone), Irgacure 907 (2-methyl-1-[4-(methylthio)phenyl]-2-morpholino propan-1-one), Irgacure 369 (2-benzyl-2-N,N-dimethylamino-1-(4-morpholinophenyl)-1-butanone), Irgacure 500 (the combination of 1-hydroxy cyclohexyl phenyl ketone and 50% benzophenone), Irgacure 651 (2,2-dimethoxy-2phenyl acetophenone), Irgacure 1700 (the combination of bis(2,6-dimethoxybenzoyl-2,4-,4-trimethyl pentyl phosphine oxide, and 75% 2-hydroxy-2-methyl-1-phenyl-propan-1-one), DAROCUR 1173 (2-hydroxy-2-methyl-lphenyl-1-propane) and DAROCUR 4265 (the combination of 50% 2,4,6-trimethylbenzoyldiphenyl-phosphine oxide and 50% 2-hydroxy 2-methyl-1-phenyl-propan-1-one), available commercially from Ciba-Geigy Corp., Tarrytown, N.Y.; CYRACURE UVI-6974 (mixed triaryl sulfonium hexafluoroantimonate salts) and CYRACURE UVI-6990 (mixed triaryl sulfonium hexafluorophosphate salts) available commercially from Union Carbide Chemicals and Plastics Co. Inc., Danbury, Conn.; and Genocure C Q, Genocure B O K, and Genocure M. F., commercially available from Rahn Radiation Curing. The preferred photoinitiator is Irgacure 1700 commercially available from Ciba-Geigy of Tarrytown, N.Y. Combinations of these materials may also be employed herein.

The preferred woodcoat composition still further includes a flow promoting agent in an amount of about 0.1% to 8%, and preferably about 4.5%, of the woodcoat composition. Suitable flow promoting agents include Genorad 17, commercially available from Rahn Radiation Curing; and Modaflow, commercially available from Monsanto Chemical Co., St. Louis, Mo. The preferred flow promoting agent is Modaflow which is an ethyl acrylate and 2-ethylhexyl acrylate copolymer that improves the flow of the composition. Combinations of these materials may also be employed herein.

To illustrate, the following example sets forth a presently preferred woodcoat composition according to this aspect of the invention.

### EXAMPLE 1

This example provides a preferred woodcoat composition according to the invention. The woodcoat composition was made from the following components:

| | Approximate |
|---|---|
| Component | Weight % |
| Ebecryl 264 | 12.0 |
| Ebecryl 284 | 12.0 |
| IBOA | 51.5 |
| Irgacure 1700 | 8.0 |
| Ebecryl 3603 | 12.0 |
| Modaflow | 4.5 |
| Total | 100.00 |

In this example the IBOA and Irgacure 1700 are mixed in a pan with a propeller blade mixer for 30 seconds at a speed of 500 to 1000 rpm. In the next step, the Ebecryl 264, the Ebecryl 284, the Ebecryl 3603, and Modaflow are introduced into the pan and mixed for 1 to 2 minutes at a speed of 2000 rpm. The mixing is temporarily suspended if the temperature exceed 100° F.

Method for Depositing a Coating on a Wooden Substrate

In accordance with still another aspect of the invention, a method is provided for depositing an woodcoat coating on a suitable substrate. The method comprises a first step of applying a woodcoat fluid-phase composition (“woodcoat composition”) to the substrate.

The woodcoat composition comprises a mixture of aliphatic acrylated oligomers, wherein the aliphatic acrylated oligomer is present in an amount of about 10% to 40% of the woodcoat composition. The woodcoat composition also includes an acrylated epoxy oligomer in an amount of about 5% to 20%, an isobornyl acrylate monomer in an amount of about 40% to 60% of the woodcoat composition, a photoinitiator in an amount of about 4% to 12% of the woodcoat composition, and a flow promoting agent in an amount of about 0.1% to 8% of the woodcoat composition. The preferred woodcoat compositions according to this method are those described herein, for example, including the compositions described in example 1.

The woodcoat composition may be applied to the substrate using a number of different techniques. The woodcoat composition may be applied, for example, by direct brush application, or it may be sprayed onto the substrate surface. It also may be applied using a screen printing technique. In such screen printing technique, a “screen” as the term is used in the screen printing industry is used to regulate the flow of liquid composition onto the substrate surface. The woodcoat composition typically would be applied to the screen as the latter contacts the substrate. The woodcoat composition flows through the silk screen to the substrate, whereupon it adheres to the substrate at the desired film thickness. Screen printing techniques suitable for this purpose include known techniques, but wherein the process is adjusted in ways known to persons of ordinary skill in the art to accommodate the viscosity, flowability, and other properties of the liquid-phase composition, the substrate and its surface properties, etc. Flexographic techniques, for example, using pinch rollers to contact the woodcoat composition with a rolling substrate, also may be used.

The method includes a second step of illuminating the woodcoat fluid-phase composition on the substrate with an ultraviolet light to cause the woodcoat fluid-phase composition to cure into the woodcoat coating. This illumination may be carried out in any number of ways, provided the ultraviolet light or radiation impinges upon the woodcoat composition so that the woodcoat composition is caused to polymerize to form the coating, layer, film, etc., and thereby cures.

Curing preferably takes place by free radical polymerization, which is initiated by an ultraviolet radiation source. The photoinitiator preferably comprises a photoinitiator, as described above.

Various ultraviolet light sources may be used, depending on the application. Preferred ultraviolet radiation sources for a number of applications include known ultraviolet lighting equipment with energy intensity settings of, for example, 125 watts, 200 watts, and 300 watts per square inch.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A photocurable woodcoat composition comprising:
an acrylated aliphatic oligomer mixture;
an acrylated epoxy oligomer;
an isobornyl acrylate monomer;
a flow promoting agent; and
a photoinitiator
wherein the photocurable composition is capable of being cured into a protective coating on a wood object and does not contain any significant amounts of volatile organic solvents that are not incorporated into the protective coating.

2. The photocurable woodcoat composition of claim 1 wherein:
the acrylated epoxy oligomer is about 5% to 20% of the weight of the woodcoat composition;
the isobornyl acrylate monomer is about 40% to 60% of the weight of the woodcoat composition;
the photoinitiator is about 4% to 12% of the weight of the woodcoat composition;
the acrylated aliphatic oligomer mixture is about 10% to 40% of the weight of the woodcoat composition; and
the flow promoting agent is present in an amount of about 0.1% to 8% of the weight of the woodcoat composition.

3. The photocurable woodcoat composition of claim 1 wherein:
the acrylated epoxy oligomer is about 8% to 16% of the weight of the woodcoat composition;
the isobornyl acrylate monomer is about 45% to 55% of the weight of the woodcoat composition;
the photoinitiator is about 6% to 10% of the weight of the woodcoat composition;
the acrylated aliphatic oligomer mixture is about 20% to 30% of the weight of the woodcoat composition; and
the flow promoting agent is about 0.1% to 8% of the weight of the woodcoat composition.

4. The photocurable woodcoat composition of claim 1 wherein:
the acrylated epoxy oligomer is about 12% of the weight of the woodcoat composition;
the isobornyl acrylate monomer is about 52% of the weight of the woodcoat composition;
the photoinitiator is about 8% of the weight of the woodcoat composition;
the acrylated aliphatic oligomer mixture is about 24% of the weight of the woodcoat composition; and
the flow promoting agent is about 4.5% of the weight of the woodcoat composition.

5. The woodcoat composition of claim 1 wherein the isobornyl acrylate monomer is selected from the group consisting of isobornyl acrylate, isobornyl methacrylate, and mixtures thereof.

6. The woodcoat composition of claim 1 wherein the photoinitiator is selected from the group consisting of:
1-hydroxycyclohexyl phenyl ketone;
2-methyl-1-[4-(methylthio)phenyl]-2-morpholino propan-1-;
the combination of 50% 1-hydroxy cyclohexyl phenyl ketone and 50% benzophenone;
2,2-dimethoxy-1,2-diphenylethan-1-one;
the combination of 25% bis(2,6-dimethoxybenzoyl-2,4-, 4-trimethyl pentyl phosphine oxide and 75% 2-hydroxy-2-methyl-1-phenyl-propan-1-one;
2-hydroxy-2-methyl-1-phenyl-1-propane;
the combination of 50% 2,4,6-trimethylbenzoyldiphenyl-phosphine oxide and 50% 2-hydroxy 2-methyl-1-phenyl-propan-1-one;
mixed triaryl sulfonium hexafluoroantimonate salts, mixed triaryl sulfonium hexafluorophosphate salts; and
mixtures thereof.

7. The woodcoat composition of claim 1 wherein the acrylated epoxy oligomer is selected from the group consisting of:
novolac epoxy acrylate diluted 20% by weight with tripropylene glycol diacrylate;
difunctional bisphenol based epoxy acrylate; and
mixtures thereof.

8. The woodcoat composition of claim 1 wherein the flow promoting agent is an ethyl acrylate and 2-ethylhexyl acrylate copolymer.

9. A method for coating a substrate with a photocurable woodcoat composition, the method comprising:
applying the woodcoat composition to the substrate, wherein the woodcoat composition includes:
the acrylated epoxy oligomer in an amount of about 5% to 20% of the weight of the woodcoat composition;
the isobornyl acrylate monomer in an amount of about 40% to 60% of the weight of the woodcoat composition;
the photoinitiator in an amount of about 4% to 12% of the weight of the woodcoat composition;
the acrylated aliphatic oligomer mixture in an amount of about 10% to 40% of the weight of the woodcoat composition; and
the flow promoting agent in an amount of about 0.1% to 8% of the weight of the woodcoat composition; and
illuminating the woodcoat composition with an UV light sufficient to cause the woodcoat composition to be cured into a protective coating;
wherein the woodcoat composition does not contain any significant amounts of volatile organic solvents that are not incorporated into the protective coating.

10. The method of claim 9, wherein UV light used in illuminating impinges upon the woodcoat composition so that the woodcoat composition is caused to form a coating as it cures.

11. The method of claim 9, wherein the method of applying the woodcoat composition is spraying.

12. The method of claim 9, wherein the method of applying the woodcoat composition is screen printing.

13. The method of claim 9, wherein the method of applying the woodcoat composition is dipping the substrate into the composition sufficiently to cause the composition to uniformly coat the substrate.

14. The method of claim 9, wherein the method of applying the woodcoat composition is brushing.

15. The method of claim 9, wherein the method of applying the woodcoat composition is selectively depositing to the substrate at predetermined locations.

16. A method for coating a substrate with a photocurable woodcoat compostion, the method comprising:
applying the woodcoat composition to the substrate, wherein the woodcoat composition includes:
the acrylated epoxy oligomer in an amount of about 8% to 16% of the weight of the woodcoat composition;
the isobornyl acrylate monomer in an amount of about 45% to 55% of the weight of the woodcoat composition;
the photoinitiator in an amount of about 6% to 10% of the weight of the woodcoat composition;
the acrylated aliphatic oligomer mixture in an amount of about 20% to 30% of the weight of the woodcoat composition; and
the flow promoting agent in an amount of about 0.1% to 8% of the weight of the woodcoat composition; and
illuminating the woodcoat composition with an UV light sufficient to cause the woodcoat composition to be cured into a protective coating;
wherein the woodcoat composition does not contain any significant amounts of volatile organic solvents that are not incorporated into the protective coating.

17. The method of claim 16, wherein:
the acrylated epoxy oligomer is about 12% of the weight of the woodcoat composition;
the isobornyl acrylate monomer is about 52% of the weight of the woodcoat composition;
the photoinitiator is about 8% of the weight of the woodcoat composition;
the acrylated aliphatic oligomer mixture is about 24% of the weight of the woodcoat composition; and
the flow promoting agent is about 4.5% of the weight of the woodcoat composition.

18. A method of making a photocurable woodcoat composition comprising:
mixing an isobornyl acrylate monomer and a photoinitiator in a pan;
introducing a flow promoting agent and an acrylated epoxy oligomer into the pan;
mixing the flow promoting agent and the acrylated epoxy oligomer.
